(19) United States
(12) Patent Application Publication
(10) Pub. No.: US 2026/0169555 A1
(43) Pub. Date: Jun. 18, 2026

(54) INFORMATION DETERMINING METHOD, HEAD-MOUNTED DEVICE, STORAGE MEDIUM, AND PROGRAM PRODUCT

(71) Applicant: Beijing Zitiao Network Technology Co., Ltd., Beijing (CN)

(72) Inventors: Xujie TAO, Beijing (CN); Jia GUO, Beijing (CN); Mengqian LIU, Beijing (CN); Shuo LIU, Beijing (CN); Jie LIN, Beijing (CN)

(21) Appl. No.: 19/351,028

(22) Filed: Oct. 6, 2025

(30) Foreign Application Priority Data
Dec. 13, 2024 (CN) 202411846422.0

(51) Int. Cl. G06F 3/01; G06V 10/32; G06V 20/20

(52) U.S. Cl. CPC G06F 3/013; G06F 3/012; G06V 10/32; G06V 20/20

(57) ABSTRACT

The embodiments of the present disclosure provide an information determining method, a head-mounted device, a storage medium, and a program product. The method is applied to a head-mounted device, the head-mounted device includes a pair of electrodes which are asymmetrically disposed, and the method includes: acquiring asymmetric electrode data, where the asymmetric electrode data is collected by the pair of electrodes, and determining user head information according to the asymmetric electrode data.

### CROSS-REFERENCE TO RELATED APPLICATIONS

This application claims priority to Chinese Patent Application No. 202411846422.0 entitled “INFORMATION DETERMINING METHOD, HEAD-MOUNTED DEVICE, STORAGE MEDIUM, AND PROGRAM PRODUCT” and filed on Dec. 13, 2024, the disclosure of which is hereby incorporated by reference in its entirety.

### TECHNICAL FIELD

The present disclosure relates to the technical field of extended reality, and in particular, to an information determining method, a head-mounted device, a storage medium, and a program product.

### BACKGROUND

With the development of extended reality technologies, users have higher and higher demands on light weight and long-time wearing comfort of head-mounted devices.

In the related art, the head-mounted device may use a conventional eye movement tracker composed of a complex optical system, a sensor, and a data processing unit to determine information such as a user gaze direction.

### SUMMARY

In a first aspect, an embodiment of the present disclosure provides an information determining method, applied to a head-mounted device, where the head-mounted device includes a pair of electrodes which are asymmetrically disposed; and the method includes:
acquiring asymmetric electrode data; where the asymmetric electrode data is collected by the pair of electrodes; and determining user head information according to the asymmetric electrode data.

In a second aspect, an embodiment of the present disclosure provides a head-mounted device, including:
an acquisition module configured to acquire asymmetric electrode data; where the asymmetric electrode data is collected by the pair of electrodes; and
a determination module configured to determine user head information according to the asymmetric electrode data.

In a third aspect, an embodiment of the present disclosure provides a head-mounted device, including:
a pair of electrodes which are asymmetrically disposed, a processor, and a memory; where
   the pair of electrodes is configured to collect asymmetric electrode data;
   the memory stores computer-executable instructions; and
   the processor executes the computer-executable instructions stored in the memory, to cause the processor to perform the information determining method as described above in the first aspect and various possible designs of the first aspect.

In a fourth aspect, an embodiment of the present disclosure provides a non-transitory computer-readable storage medium having stored thereon computer-executable instructions which, when executed by a processor, implement the information determining method as described above in the first aspect and various possible designs of the first aspect.

In a fifth aspect, an embodiment of the present disclosure provides a computer program product including a computer program which, when executed by a processor, implements the information determining method as described above in the first aspect and various possible designs of the first aspect.

### BRIEF DESCRIPTION OF THE DRAWINGS

In order to more clearly illustrate the embodiments of the present disclosure or technical solutions in the prior art, the drawings used in the description of the embodiments or the prior art will be briefly described below, and it is obvious that the drawings in the following description are some embodiments of the present disclosure, and those skilled in the art can obtain other drawings without creative labor.

FIG. 1 is a schematic diagram of an application scenario of an information determining method according to an embodiment of the present disclosure;

FIG. 2 is a schematic flow diagram of an information determining method according to an embodiment of the present disclosure;

FIGS. 3a to 3d are schematic diagrams of a user window division method according to an embodiment of the present disclosure;

FIGS. 4a to 4b are schematic diagrams of a process of simplifying image data according to an embodiment of the present disclosure;

FIG. 5 is a schematic functional block diagram of a head-mounted device according to an embodiment of the present disclosure;

FIG. 6 is a schematic flow diagram of a model training method of a target model according to an embodiment of the present disclosure;

FIG. 7 is a block diagram of a head-mounted device according to an embodiment of the present disclosure; and

FIG. 8 is a schematic diagram of a hardware structure of an electronic device according to an embodiment of the present disclosure.

### DETAILED DESCRIPTION

To make the objectives, technical solutions and advantages of the embodiments of the present disclosure more apparent, the technical solutions in the embodiments of the present disclosure will be described clearly and completely with reference to the drawings in the embodiments of the present disclosure, and it is apparent that the described embodiments are some, but not all embodiments of the present disclosure. All other embodiments, which can be derived by a person skilled in the art from the embodiments disclosed herein without creative labor, are intended to be within the scope of the present disclosure.

The inventors of the present disclosure have found that the traditional eye movement tracking mode at least has the following technical problems: the head-mounted device is heavy in weight, low in wearing comfort, and relatively poor in user experience.

Embodiments of the present disclosure provide an information determining method, a head-mounted device, a storage medium, and a program product, so as to improve the light weight and wearing comfort of the head-mounted device and improve the user experience.

According to the information determining method, the head-mounted device, the storage medium, and the program product provided by the embodiments, the method is applied to the head-mounted device, the head-mounted device includes a pair of electrodes which are asymmetrically disposed, and the method includes:
acquiring asymmetric electrode data, where the asymmetric electrode data is collected by the pair of electrodes, and determining user head information according to the asymmetric electrode data. According to the information determining method provided by the embodiment of the present disclosure, the head-mounted device has the capability of determining various user information (e.g., a gaze direction) by adopting the pair of electrodes which are asymmetrically disposed, so as to realize user interaction of the head-mounted device based on the determined user head information, and the pair of electrodes is light in weight, making the head-mounted device more lightweight, improving the long-time wearing comfort, and further improving the user experience.

The intelligent question-answering technology is gradually changing the life style of people by virtue of characteristics of high efficiency, convenience and individuation, and brings more comfortable and convenient life experience for people. With the rapid development of Extended Reality (XR) technologies (including Augmented Reality (AR), Virtual Reality (VR), and Mixed Reality (MR)), XR devices have become possible to provide intelligent query services for users.

In the related art, the XR device may obtain a matching answer statement according to a query statement inputted by a user. However, the accuracy of the query result is relatively low.

In order to solve the above technical problem, the inventors of the present disclosure have studied and found that, an image shot when a user queries, that is, a scene before the user's eyes, can be combined with a query statement to improve the accuracy of processing result. In order to avoid processing delay caused by a large amount of data and information of the shot image, and to ensure the lightweight and portability of the XR device, the inventors have further studied and found that, a potential change generated by eyeball movement of the user can be collected (instead of adopting a traditional eye movement tracker with a large volume and complex structure) by adopting a pair of electrodes (the cornea is positively charged, the retina is negatively charged, and the eye will generate different potential differences when in different positions, so that notable characteristic waveforms under eyeball movements such as moving upward, downward, leftward, rightward and the like of the user's eye can be collected by adopting an electrode layout mode), a gaze area of the user is further determined based on the collected electrode data, the image data is processed based on the gaze area, and the processed image data is combined with query information to obtain an answer result, improving the accuracy of the result, and not only reducing the delay and improving the real-time performance, but also ensuring the lightweight and portability of the XR device. Based on this, an embodiment of the present disclosure provides an information determining method.

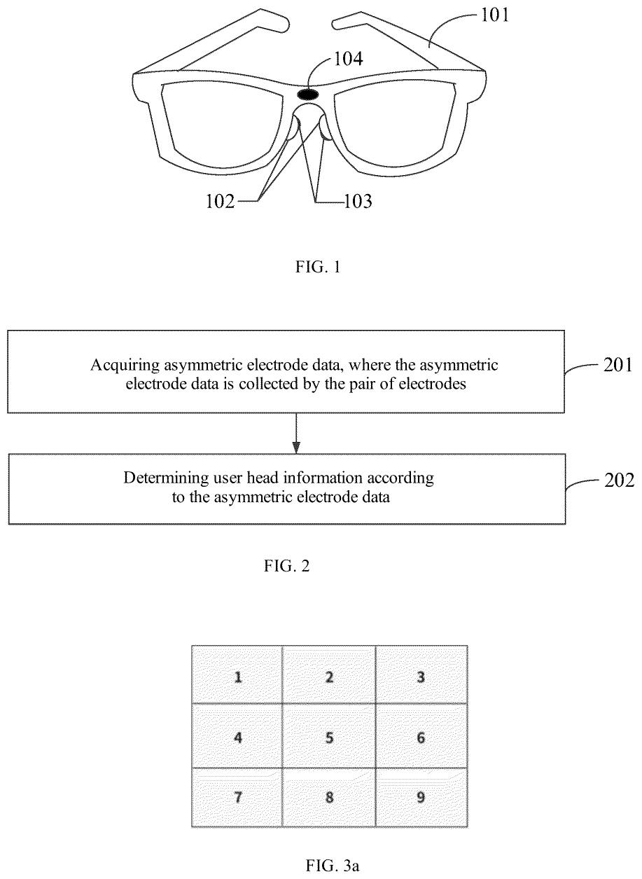

FIG. 1 is a schematic diagram of an application scenario of an information determining method according to an embodiment of the present disclosure. As shown in FIG. 1, taking a head-mounted device being eyeglasses as an example, the eyeglasses 101 include a pair of nose pads 102, a pair of electrodes 103, and a camera 104. The camera 104 can be disposed on a spectacle frame. The pair of nose pads 102 may be symmetrically disposed centering on a perpendicular bisector of a line connecting center points of two spectacle lenses, one electrode of the pair of electrodes 103 is disposed inside (a side in contact with a nose) one of the pair of nose pads 102, and the other electrode is disposed inside the other of the pair of nose pads 102. As shown in FIG. 1, two electrodes of the pair of electrodes 103 may be disposed up and down in a staggered manner, that is, a connecting line between the two electrodes forms an angle with the connecting line between the center points of the lenses. Optionally, an electrode material of the pair of electrodes 103 may be silver plated with silver chloride, copper plated with silver chloride, or copper plated with gold. Optionally, the eyeglasses 101 may be ordinary eyeglasses, or smart eyeglasses carrying a sensor such as a camera, or XR eyeglasses. Optionally, the pair of nose pads 102 is a portion of the eyeglasses 101 in contact with the nose, and may be disposed integrally with the eyeglasses or disposed as a separate component protruding from the eyeglasses, which is not limited in the embodiment of the present disclosure.

In a specific implementation, a user wears the eyeglasses 101, the pair of electrodes 103 contacts with a nose wing of the user to collect asymmetric electrode data, the eyeglasses 101 acquire the asymmetric electrode data, and user head information is determined according to the asymmetric electrode data. According to the information determining method provided by the embodiment of the present disclosure, the head-mounted device has the capability of determining various user information (e.g., a gaze direction) by adopting the pair of electrodes which are asymmetrically disposed, so as to realize user interaction of the head-mounted device based on the determined user head information, and the pair of electrodes is light in weight, making the head-mounted device lighter, improving the long-time wearing comfort, and further improving the user experience.

It should be noted that the schematic scenario diagram shown in FIG. 1 is only an example, and the information determining method and the scenario described in the embodiment of the present application are used to more clearly illustrate the technical solution of the embodiment of the present application, and do not form a limitation on the technical solution provided in the embodiment of the present application, and it is known to those skilled in the art that with the evolution of the system and the emergence of new business scenarios, the technical solution provided by the embodiment of the present application is also applicable to similar technical problems.

The technical solution of the present application will be described in detail below with reference to specific embodiments. The several specific embodiments may be combined with each other below, and details of the same or similar concepts or processes may not be repeated in some embodiments.

Referring to FIG. 2, FIG. 2 is a schematic flow diagram of an information determining method according to an embodiment of the present disclosure. As shown in FIG. 2, the information determining method is applied to a head-mounted device, the head-mounted device includes a pair of electrodes which are asymmetrically disposed, and the method includes:
201: acquiring asymmetric electrode data; wherein the asymmetric electrode data is collected by the pair of electrodes.

An execution subject of the embodiment of the present disclosure may be a head-mounted device such as an XR device, the head-mounted device may be a device worn on the head, face, eyes, etc., such as the XR eyeglasses shown in FIG. 1, and may also be a wearable device covering at least part of the head, face, and eyes.

In an embodiment of the present disclosure, two electrodes of the pair of electrodes are disposed asymmetrically with respect to a symmetry plane of user's head. The symmetry plane of the user′ head is a plane which is bilaterally symmetric with respect to the face/brain, namely a midperpendicular plane which passes from the forehead to the back occipital part of the user's head through a central point of the tragus at both sides.

In an embodiment of the present disclosure, the head-mounted device is an eye-mounted device. The eye-mounted device may be the XR eyeglasses as shown in FIG. 1, and the pair of electrodes may be provided on eyeglasses temples, or on the pair of nose pads, etc.

In an embodiment of the present disclosure, the pair of electrodes may be asymmetrically disposed on the pair of nose pads of the head-mounted device. As shown in FIG. 1, one electrode of the pair of electrodes is disposed at a first location point on a target side of one of the pair of nose pads and the other electrode of the pair of electrodes is disposed at a second location point on a target side of the other of the pair of nose pads; the target side is a side in contact with a human body; and an angle is formed between a connecting line between the first location point and the second location point and a straight line where the two eyes are located.
202: determining user head information according to the asymmetric electrode data.

Specifically, after the asymmetric electrode data is acquired, the asymmetric electrode data may be processed (for example, waveform comparison, or inputting to a deep learning model for recognition processing, etc.) to determine user head information, such as user gaze area information, eye movement information, etc.

As can be seen from the above description, the information determining method according to the embodiment of the present disclosure enables the head-mounted device to have the capability of determining various user information (for example, a gaze direction) by adopting the pair of electrodes which are asymmetrically disposed, so as to realize user interaction of the head-mounted device based on the determined user head information, and the pair of electrodes is light in weight, making the head-mounted device lighter, improving the long-time wearing comfort, and further improving the user experience.

In an embodiment of the present disclosure, the user head information includes gaze area information.

In an embodiment of the present disclosure, determining the user head information according to the asymmetric electrode data may include: inputting the asymmetric electrode data into a target model to obtain the gaze area information of a user.

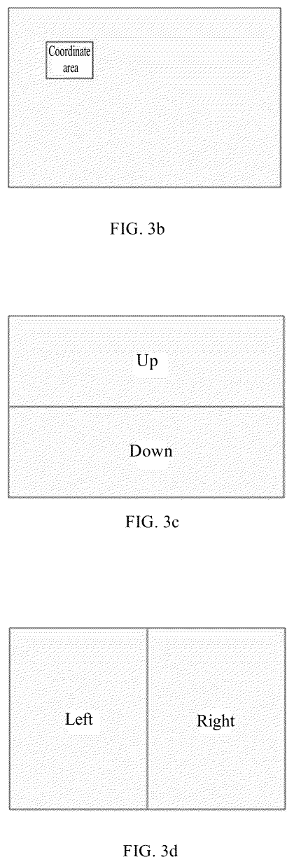

Specifically, granularity of the gaze area is related to samples used in the training of the target model. If a fine granularity of the gaze area is required, such as a nine-square grid shown in FIG. 3a or an arbitrary coordinate area shown in FIG. 3b, the training can be made with this granularity of samples. If a coarse granularity of the gaze area is required, for example, a vertically divided area as shown in FIG. 3c or a horizontally divided coordinate area as shown in FIG. 3d, training can be made with this granularity of samples.

In the embodiments of the present disclosure, the target model may be a neural network model. In order to ensure lightweight and processing accuracy, a neural network model composed of a convolutional neural network Conv and a long and short memory network LSTM can be adopted. Specifically, the object model may include: a first network structure, a second network structure, and a multilayer perceptron MLP; the first network structure includes a first convolution network and a first long and short memory network which are sequentially connected in series; the second network structure includes a second convolution network and a second long and short memory network which are sequentially connected in series; the first network structure and the second network structure are both connected with the multilayer perceptron; the first network structure is used for processing first electrode data to obtain first intermediate data; the second network structure is used for processing preset characteristics to obtain second intermediate data; the multilayer perceptron is used for fusing the first intermediate data and the second intermediate data to obtain a classification result; the classification result includes a gaze area corresponding to the first electrode data. The first convolutional network and the second convolutional network may both be a one-dimensional convolutional neural network, and may be disposed in two layers. The first long and short memory network and the second long and short memory network may be disposed in two layers. Activation functions adopted by the first network structure and the second network structure may be Relu activation functions.

In an embodiment of the present disclosure, after the step 202, the method may further include: acquiring query information and image data corresponding to the query information; and determining answer information corresponding to the query information according to the query information, the image data, and the gaze area information.

In an embodiment of the present disclosure, the query information may include at least one of the following: text data, voice data, or video data. The image data may be image data obtained by shooting with a camera disposed on the head-mounted device. The image data may be image data obtained by shooting at query information input timing based on a time stamp.

In an embodiment of the present disclosure, determining the answer information corresponding to the query information according to the query information, the image data, and the gaze area information may include: processing the image data according to a gaze area corresponding to the gaze area information to obtain a target image corresponding to the image data; and determining feedback information corresponding to the query information according to the query information and the target image.

Specifically, due to high definition of the image and overlarge amount of information in the image, an inference effect of the model may not be directly improved. In many cases, the model needs to focus more on core features related to a task than on all details. High resolution or information intensive images may instead increase processing burdens, leading to wasted resources and even increased noise interference. After the gaze area of the user is determined, a part concerned by the user can be determined from the image data based on the gaze area, and then the concerned part is combined with the query information to determine an answer result, avoiding processing delay caused by the overlarge information amount and data amount of the whole image data, and improving the real-time performance and the accuracy of the processing.

After the target image is determined based on the gaze area, the target image can be combined with the query information to assist in determining answer information, improving the accuracy. Illustratively, the target image and the query information may be first preprocessed separately: text-preprocessing the query information, such as word segmentation, stop word removal, word stem extraction and the like; image preprocessing the target image, such as size adjustment, color correction, noise removal and the like. And then, feature extraction is performed: performing semantic analysis on the query information, to extract keywords and topics; performing feature extraction on the target image, such as edge detection, texture analysis, object recognition, and the like, to obtain key information in the image. Then information fusion is performed: fusing semantic features of the query information and the features of the target image to form a comprehensive feature vector. Machine learning or deep learning algorithms can be employed to further perform information retrieval/matching: comparing the fused feature vector with information in a database to find out the most matched answer information. The database can be a pre-constructed knowledge base or a real-time updated network index. Finally, the answer information is returned: returning the most relevant answer information to the user according to the matching result. The answer information may be in a variety of forms such as text, image, video, etc.

In an embodiment of the present disclosure, processing the image data according to the gaze area corresponding to the gaze area information to obtain a target image corresponding to the image data may include: mapping the gaze area in the image data to obtain a target area corresponding to the gaze area in the image data; and simplifying the image data based on the target area to obtain the target image corresponding to the image data.

In this way, the model can more accurately understand the user references (user gesture, voice, etc.), and at the same time, the efficiency performance is improved, and the inference cost is reduced (vector tokens are reduced).

In an embodiment of the present disclosure, there are various ways of simplifying the image data based on the target area, and in one implementation, cropping and resolution reduction may be performed. Specifically, simplifying the image data based on the target area to obtain the target image corresponding to the image data may include: cropping the image data based on the target area to obtain a first image corresponding to the target area in the image data; and determining the first image as the target image corresponding to the image data, or reducing resolution of the first image to obtain the target image corresponding to the image data. In another implementation, resolution of non-essential parts may be reduced. Specifically, an image outside the target area in the image data may be resolution-reduced, so as to obtain the target image corresponding to the image data.

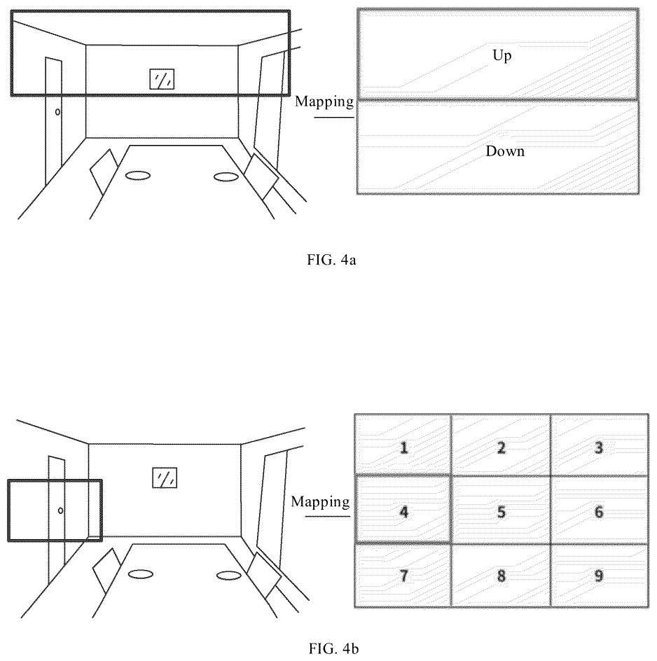

For example, as shown in FIG. 4a, if the gaze area of the current user is an upward-looking area, the upper half of the image may be retained as the target image, and the lower half of the image may be cropped out. As shown in FIG. 4 b, if the gaze area of the current user is an area corresponding to 4 in the nine-square grid, the image may be divided according to the nine-square grid, the image in the area corresponding to 4 is retained as the target image, and the rest of the image is cropped out.

In an embodiment of the present disclosure, to improve accuracy, a multimodal model may be employed to identify the target image and query information. Specifically, determining the answer information corresponding to the query information according to the query information and the target image may include: inputting the target image and the query information into a multimodal model to obtain the answer information corresponding to the query information.

In an embodiment of the present disclosure, the image data may be image data collected based on query information input timing, and if the image data at the same timing is not related to the query information, historical image data (i.e., image data collected before the query information input timing) may be searched in a storage path as the target image, and related information may also be searched in a non-gaze area of the image data to determine the target image. Illustratively, the query information inputted by the user is “regarding the book read in the morning, who is the author ?”, and the book may not appear in the user's visual field, so the head-mounted device may search the images acquired in the morning for an image where the book exists as the target image.

Illustratively, as shown in FIG. 5, the user inputs query information Query containing text/voice and image (shot by a camera). The electrode data characterizing eyeball movement of the user can be collected in real time by electrodes disposed up and down in a staggered manner on XR hardware. An eye state of the user, including an eyeball movement direction, is analyzed in real-time using a target model (e.g., a lightweight local model) trained based on eye movement data. Based on the analyzed eye state, the image shot by the camera is intelligently mapped and cropped, to accurately position the direction/area concerned by the user, and obtain a target image. The target image is integrated with the text/voice, and the integrated multimodal data is transmitted to a large multimodal language model (MLLM) for further processing and analysis, to obtain answer information. In the embodiment of the present disclosure, the efficiency performance of the model is improved and the inference cost is reduced (because the image has been cropped, the number of tokens generated is correspondingly reduced). The reference is more explicit. For example, interaction modalities such as gesture and voice of the user are better combined, making semantic references in the channels are more explicit. The eye movement tracking function of the lightweight XR device is realized, without a large-volume or complex tracking device, thereby reducing the device weight, and meeting the requirement of lightweight industrial design. By analyzing the eye state (eye movement direction and/or blink) of the user, the performance efficiency of the model is improved, the inference cost is reduced, and a more accurate inference result is realized.

As can be seen from the above description, in the information determining method according to the embodiment of the present disclosure, by collecting a potential change generated by the eyeball movement of the user using the pair of electrodes, determining the gaze area of the user based on the collected electrode data, processing the image data based on the gaze area, and combining the processed image data with the query information to obtain an answer result, the accuracy of the result is improved, and, not only the delay is reduced, and the real-time performance is improved, but also the lightweight and portability of the XR device are ensured.

Because the electric potential collected by the pair of electrodes can characterize various information such as eye movement direction, blinking, material of contact articles, distance from the human body, the various information can be determined based on the asymmetric electrode data, and the method is appliable to various scenes.

In an embodiment of the present disclosure, blink frequency and the like may be identified through the pair of electrodes, so that a current state of the user may be determined, thereby performing different processing; specifically, the user head information includes eye movement information, and the method further includes: determining a user state according to the eye movement information; and determining a corresponding processing result according to the user state.

Specifically, the potential change caused by the blinking of the user can be acquired through the pair of electrodes when the user wears the head-mounted device.

In an embodiment of the present disclosure, determining the corresponding processing result according to the user state may include: if the user state is a fatigue state, sending a rest prompt; if the user state is a distraction state, sending warning information; if the user state is a reading state, controlling the head-mounted device to enter an anti-disturbance mode; and if the user state is a preset blink state, generating a first instruction according to the target blink state, and performing a corresponding first operation in response to the first instruction.

Fatigue is directly related to changes in blink characteristics, such as frequency and duration: greater fatigue leads to higher blink frequency (BF) and longer blink time. Further, as the degree of fatigue increases, the blink frequency increases, the eye movement speed decreases, and the blink duration becomes longer.

In particular, in one application scenario, a specific blinking motion of the user, for example, blinking twice in rapid succession, may be taken as an instruction motion. For example, the instruction action may be used to perform operations such as opening an application, clicking a button. In another application scenario, the fatigue state of a user may be identified, for affecting the output of the model and the judgment of the end. For example, when broadcasting news, if the user is found to be tired or fall asleep, it decreases the volume/ends. It can also be used in emotion accompany interaction, for example, when eye fatigue of a user is detected, the user is reminded to take a rest in time. When the user's attention is detected to be inattentive, it may be used for reminding or warning. For example, when the driver is found to be inattentive while driving, the system will issue a warning to alert the user to safety. If the user is found to be reading, for example, an anti-disturbance mode may be enabled, during which content/information is not actively pushed to the user.

In an embodiment of the present disclosure, human body activities in the surrounding environment may be sensed by the electrodes. Specifically, the method may further include: determining a human body activity category according to the asymmetric electrode data; and determining a corresponding processing result according to the human body activity category, where the asymmetric electrode data includes a potential change resulting from the human body activity in a surrounding environment when the head-mounted device is not worn.

In an embodiment of the present disclosure, determining the corresponding processing result according to the human body activity category may include: if the human body activity category is a preset air gesture, generating a second instruction according to the air gesture category, and performing a corresponding second operation in response to the second instruction; if the human body activity category is that the human body walks back and forth, generating a sound prompt; and if the human body activity category is human body approaching activity, controlling the head-mounted device to enter a pre-awakening state.

In particular, in one application scenario, when the head-mounted device, such as eyeglasses, is placed on a desktop, the pair of electrodes of the eyeglasses are able to perceive coarse gesture information around. This function not only can recognize simple gesture commands, but also can transform the eyeglasses into an interactive device, similar to a touch button. The user can trigger a preset operation or command by making a specific gesture near the eyeglasses, so that a non-contact human-computer interaction is realized. This functionality expands the use scenario of the eyeglasses, allowing them to function when not worn. The electrodes cannot be in contact with the skin of the user. In another application scenario, when the head-mounted device, such as eyeglasses, is placed on a table, whether someone passes nearby is roughly sensed through the electrodes, as an extension direction of the scene recognition function. For example, when sensing that someone is walking around frequently, the device may speculate that the user may be looking for the eyeglasses, thereby sending a sound prompt; or automatically enter a pre-awakening state when a user approaches. The electrodes cannot be in contact with the skin of the user.

In an embodiment of the present disclosure, the material of the object in contact may be sensed through the pair of electrodes, and specifically, the method may further include: determining a material category of an object in contact according to the asymmetric electrode data; and determining a position of the head-mounted device according to the material category. The asymmetric electrode data includes a potential change resulting from an object material in contact with the pair of electrodes in a surrounding environment when the head-mounted device is not worn.

In particular, in an application scenario, the electrodes on the head-mounted device, such as eyeglasses, may sense the material of the object in contact with the electrodes, especially different types of cloth. This functionality can be applied to help users find their eyeglasses through a cell phone application. For example, when the user cannot find the eyeglasses, the application program may analyze the material information sensed by the electrodes to infer a possible location of the eyeglasses, such as in a bag or a pocket of clothing, thereby helping the user find the eyeglasses more quickly. The electrodes cannot be in contact with the skin of the user.

In an embodiment of the present disclosure, a facial touch action may be sensed by the electrodes, and specifically, the method may further include: determining a facial touch action category according to the asymmetric electrode data; and performing a corresponding operation in response to an instruction generated according to the facial touch action category. The asymmetric electrode data includes a potential change resulting from a user touching the face when the head-mounted device is worn by the user.

Specifically, in an application scenario, the detection of user expression (coarse granularity) through the pair of electrodes can assist other sensors to be more accurate. It can also be taken as an action control. For example, when the user touches the nose (like touching a button), it is used for opening an application, clicking a button, and the like.

From the above description, the target model provided by the embodiment of the present disclosure has multi-functionality, and can be applied to various scenes, thereby improving the user experience.

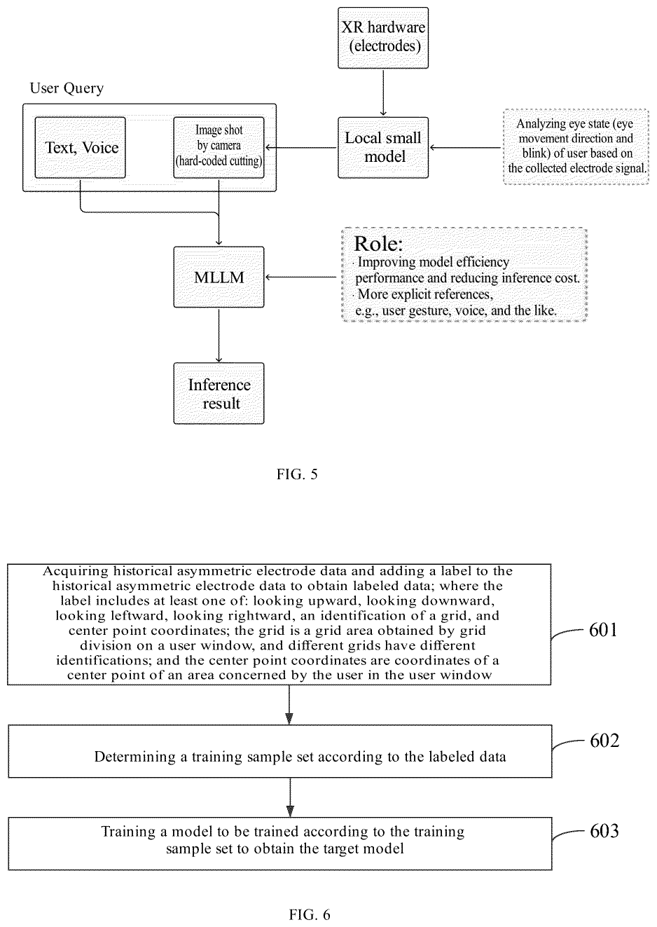

Referring to FIG. 6, FIG. 6 is a schematic flow diagram of a model training method of the target model according to an embodiment of the present disclosure. The method includes:
601: acquiring historical asymmetric electrode data, and adding a label to the historical asymmetric electrode data to obtain labeled data; where the label includes at least one of: looking upward, looking downward, looking leftward, looking rightward, an identification of a grid, and center point coordinates; the grid is a grid area obtained by grid division on a user window, and different grids have different identifications; and the center point coordinates are coordinates of a center point of an area concerned by the user in the user window;
602: determining a training sample set according to the first labeled data; and
603: training a model to be trained according to the training sample set to obtain the target model.

As can be seen from the above description, in the model training method provided in the embodiment of the present disclosure, by using the historical asymmetric electrode data generated from eyeball movement, and labeling the historical asymmetric electrode data, a rich training sample set can be obtained, and the target model with high accuracy can be obtained through training.

In an embodiment of the present disclosure, in order to enable the target model to recognize various user states, the historical asymmetric electrode data may include electrode data generated in various user states for model training after labeling, and specifically, at least one of the following labels may be used when determining the labeled data: fatigue state, distraction state, reading state, or preset blink state.

In an embodiment of the present disclosure, in order to enable the target model to recognize various facial touch actions, the historical asymmetric electrode data may include electrode data generated when various facial touch actions occur, so as to be labeled for model training, and specifically, when determining the labeled data, the following label may be used: a facial touch action category.

In an embodiment of the present disclosure, in order to enable the target model to identify a scene when the pair of electrodes is not in contact with the human body, the historical asymmetric electrode data may include electrode data generated in various scenes, so as to be labeled for model training, and specifically, at least one of the following labels may be used when determining the labeled data: material category, preset air gesture, human body moving back and forth, and human body approaching movement.

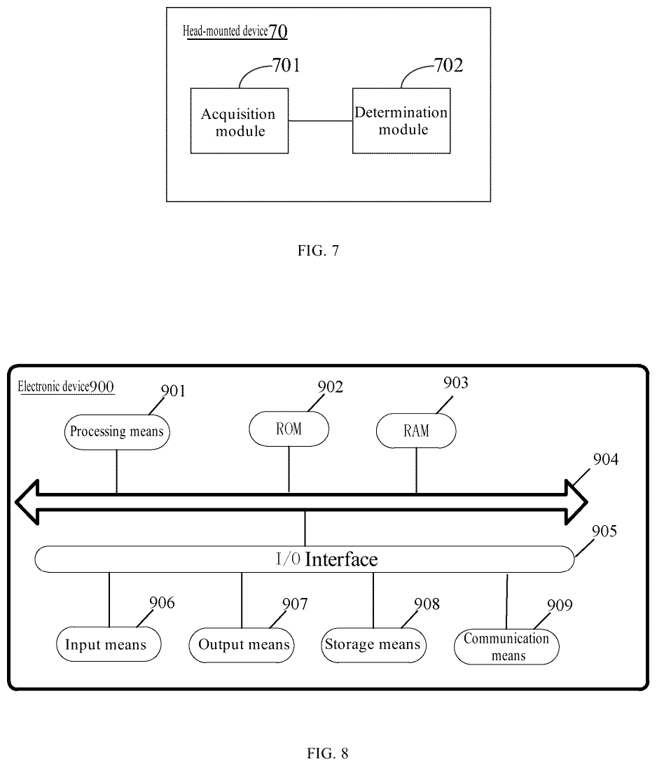

Corresponding to the information determining method of the foregoing embodiment, FIG. 7 is a block diagram of a head-mounted device according to an embodiment of the present disclosure. For ease of illustration, only portions relevant to the embodiments of the present disclosure are shown. Referring to FIG. 7, the device 70 includes: an acquisition module 701 and a determination module 702.

The acquisition module 701 is configured to acquire asymmetric electrode data; where the asymmetric electrode data is collected by the pair of electrodes; and
The determination module 702 is configured to determine user head information according to the asymmetric electrode data.

As can be seen from the above description, the information determining method provided in the embodiment of the present disclosure enables the head-mounted device to have the capability of determining various user information (for example, a gaze direction) by using the pair of electrodes which are asymmetrically disposed, so as to realize user interaction of the head-mounted device based on the determined user head information, and the pair of electrodes is light in weight, making the head-mounted device lighter, improving the long-time wearing comfort, and further improving the user experience.

In an embodiment of the present disclosure, two electrodes in the pair of electrodes are disposed asymmetrically with respect to a symmetry plane of user's head.

In an embodiment of the present disclosure, the head-mounted device is an eye-mounted device.

In an embodiment of the present disclosure, the eye-mounted device includes a pair of nose pads; and the pair of electrodes is disposed on the pair of nose pads.

In an embodiment of the present disclosure, the user head information includes gaze area information.

In an embodiment of the present disclosure, the determination module 702 is further configured to: acquire query information and image data corresponding to the query information; and determine answer information corresponding to the query information according to the query information, the image data, and the gaze area information.

In an embodiment of the present disclosure, the determination module 702 is specifically configured to: process the image data according to a gaze area corresponding to the gaze area information to obtain a target image corresponding to the image data; and determine feedback information corresponding to the query information according to the query information and the target image.

In an embodiment of the present disclosure, the determination module 702 is specifically configured to: map the gaze area in the image data to obtain a target area corresponding to the gaze area in the image data; and simplify the image data based on the target area to obtain the target image corresponding to the image data.

In an embodiment of the present disclosure, the determination module 702 is specifically configured to: crop the image data based on the target area to obtain a first image corresponding to the target area in the image data; and determine the first image as the target image corresponding to the image data, or reduce resolution of the first image to obtain the target image corresponding to the image data.

In an embodiment of the present disclosure, the determination module 702 is specifically configured to: input the asymmetric electrode data into a target model to obtain the gaze area information of a user.

In an embodiment of the present disclosure, the determination module 702 is further configured to: acquire historical asymmetric electrode data, and add a label to the historical asymmetric electrode data to obtain labeled data; where the label comprises at least one of: looking upward, looking downward, looking leftward, looking rightward, an identification of a grid, and center point coordinates; the grid is a grid area obtained by grid division on a user window, and different grids have different identifications; and the center point coordinates are coordinates of a center point of an area concerned by the user in the user window; determine a training sample set according to the labeled data; and train a model to be trained according to the training sample set to obtain the target model.

In an embodiment of the present disclosure, the query information includes at least one of: text data, voice data, or video data.

In an embodiment of the present disclosure, the user head information includes eye movement information, and the determination module 702 is further configured to: determine a user state according to the eye movement information; and determine a corresponding processing result according to the user state.

In an embodiment of the present disclosure, the determination module 702 is further configured to: determine a human body activity category according to the asymmetric electrode data; and determine a corresponding processing result according to the human body activity category.

In an embodiment of the present disclosure, the determination module 702 is further configured to: determine a material category of an object in contact according to the asymmetric electrode data; and determine a position of the head-mounted device according to the material category.

In an embodiment of the present disclosure, the determination module 702 is further configured to: determine a facial touch action category according to the asymmetric electrode data; and perform a corresponding operation in response to an instruction generated according to the facial touch action category.

The device provided in this embodiment may be configured to implement the technical solutions of the method embodiments, and the implementation principles and technical effects are similar, which are not described herein again.

In order to implement the above embodiments, an embodiment of the present disclosure further provides an electronic device.

Referring to FIG. 8, a schematic structural diagram of an electronic device 900 suitable for implementing the embodiment of the present disclosure is shown, where the electronic device 900 may be a terminal device or a server. Among them, the terminal device may include, but is not limited to, a mobile terminal such as a mobile phone, a notebook computer, a digital broadcast receiver, a Personal Digital Assistant (PDA), a tablet computer, a Portable Multimedia Player (PMP), a car terminal (e.g., car navigation terminal), and the like, and a fixed terminal such as a digital TV, a desktop computer, and the like. The electronic device shown in FIG. 8 is only an example, and should not bring any limitation to the functions and the scope of use of the embodiments of the present disclosure.

As shown in FIG. 8, the electronic device 900 may include a processing means (e.g., a central processing unit, a graphics processor, etc.) 901, which may perform various suitable actions and processes according to a program stored in a Read Only Memory (ROM) 902 or a program loaded from a storage means 908 into a Random Access Memory (RAM) 903. In the RAM 903, various programs and data necessary for the operation of the electronic device 900 are also stored. The processing means 901, ROM 902, and RAM 903 are connected to each other via a bus 904. An input/output (I/O) interface 905 is also connected to the bus 904.

Generally, the following means may be connected to the I/O interface 905: input means 906 including, for example, a touch screen, touch pad, keyboard, mouse, camera, microphone, accelerometer, gyroscope, etc.; an output means 907 including, for example, a Liquid Crystal Display (LCD), a speaker, a vibrator, etc.; the storage means 908 including, for example, magnetic tape, hard disk, etc.; and a communication means 909. The communication means 909 may allow the electronic device 900 to communicate with other devices wirelessly or by wire to exchange data. While FIG. 8 illustrates the electronic device 900 having various means, it is to be understood that not all illustrated means are required to be implemented or provided. More or fewer means may be alternatively implemented or provided.

In an embodiment of the present disclosure, the electronic device may be a head-mounted device including: a pair of electrodes, a processor, and a memory; the pair of electrodes is used for contacting with a human body of a user when the user wears the head-mounted device to acquire a potential change generated by eyeball movement of the user; the memory stores computer-executable instructions; the processor executes the computer-executable instructions stored in the memory to cause the processor to perform the information determining method as described in the above embodiments.

In an embodiment of the present disclosure, the head-mounted device is smart eyeglasses; the smart eyeglasses include a pair of nose pads; different ones of the pair of electrodes are disposed on a target side of different ones of the pair of nose pads; the target side is a side in contact with the human body of the nose pad when the smart eyeglasses are worn by the user; a connecting line between two electrodes in the pair of electrodes is parallel to a connecting line between central points of two lenses of the smart eyeglasses, or an angle forms between the two connecting lines.

In an embodiment of the present disclosure, the pair of electrodes is made of any one of the following materials: silver plated with silver chloride, copper plated with silver chloride, or copper plated with gold.

In particular, the processes described above with reference to the flow diagrams may be implemented as computer software programs, according to the embodiments of the present disclosure. For example, the embodiments of the present disclosure include a computer program product including a computer program embodied on a computer-readable medium, the computer program including program code for performing the methods illustrated by the flow diagrams. In such an embodiment, the computer program may be downloaded and installed from a network through the communication means 909, or installed from the storage means 908, or installed from the ROM 902. The computer program, when executed by the processing means 901, performs the above-described functions defined in the methods of the embodiments of the present disclosure.

It should be noted that the computer readable medium of the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium that can contain, or store a program for use by or in connection with an instruction execution system, apparatus, or device. In contrast, in the present disclosure, the computer readable signal medium may include a propagated data signal with computer readable program code embodied therein, for example, in baseband or as part of a carrier wave. Such a propagated data signal may take any of a variety of forms, including, but not limited to, electro-magnetic, optical, or any suitable combination thereof. The computer readable signal medium may be any computer readable medium that is not a computer readable storage medium and that can communicate, propagate, or transport a program for use by or in connection with an instruction execution system, apparatus, or device. Program code embodied on the computer readable medium may be transmitted using any appropriate medium, including but not limited to: electrical wires, optical cables, RF (radio frequency), etc., or any suitable combination of the foregoing.

The computer readable medium may be embodied in the electronic device; or may be separate and not assembled into the electronic device.

The computer readable medium carries one or more programs which, when executed by the electronic device, cause the electronic device to perform the method shown in the above embodiments.

Computer program code for carrying out operations for aspects of the present disclosure may be written in any combination of one or more programming languages, including an object oriented programming language such as Java, Smalltalk, C++, and conventional procedural programming languages, such as the “C” language or similar programming languages. The program code may execute entirely on the user's computer, partly on the user's computer, as a stand-alone software package, partly on the user's computer and partly on a remote computer or entirely on the remote computer or server. In the scenario where the remote computer is involved, the remote computer may be connected to the user's computer through any type of Network, including a Local Area Network (LAN) or a Wide Area Network (WAN), or may be connected to an external computer (for example, through the Internet using an Internet service provider).

The flow and block diagrams in the figures illustrate the architecture, functionality, and operation of possible implementations of systems, methods and computer program products according to various embodiments of the present disclosure. In this regard, each block in the flow or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block and/or flow diagram, and combinations of blocks in the block and/or flow diagrams, can be implemented by special purpose hardware-based systems that perform the specified functions or actions, or combinations of special purpose hardware and computer instructions.

The units described in the embodiments of the present disclosure may be implemented by software or hardware. The name of a unit does not in some cases constitute a limitation of the unit itself, for example, a first acquisition unit may also be described as a “unit configured to acquire at least two internet protocol addresses”.

The functions described herein above may be performed, at least in part, by one or more hardware logic components. For example, without limitation, exemplary types of hardware logic components that may be used include: field Programmable Gate Array (FPGA), Application Specific Integrated Circuit (ASIC), Application Specific Standard Product (ASSP), system on a chip (SOC), Complex Programmable Logic Device (CPLD), and the like.

The foregoing is illustration of the preferred embodiments of the present disclosure and the technical principles employed. It should be appreciated by those skilled in the art that the disclosure scope involved in the present disclosure is not limited to the technical solutions formed by specific combinations of the above technical features, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited thereto) in the present disclosure.

Furthermore, while operations are depicted in a specific order, this should not be understood as requiring that these operations be performed in the specific order shown or in a sequential order. Under certain circumstances, multitasking and parallel processing may be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

1. An information determining method, applied to a head-mounted device, wherein the head-mounted device comprises a pair of electrodes which are asymmetrically disposed; and the method comprises:
acquiring asymmetric electrode data; wherein the asymmetric electrode data is collected by the pair of electrodes; and
determining user head information according to the asymmetric electrode data.

2. The method according to claim 1, wherein two electrodes of the pair of electrodes are asymmetrically disposed with respect to a symmetric plane of user's head.

3. The method according to claim 1, wherein the head-mounted device is an eye-mounted device.

4. The method according to claim 3, wherein the eye-mounted device comprises a pair of nose pads; and the pair of electrodes is disposed on the pair of nose pads.

5. The method according to claim 1, wherein the user head information comprises gaze area information.

6. The method according to claim 5, further comprising:
acquiring query information and image data corresponding to the query information; and
determining answer information corresponding to the query information according to the query information, the image data, and the gaze area information.

7. The method according to claim 6, wherein determining the answer information corresponding to the query information according to the query information, the image data, and the gaze area information comprises:
processing the image data according to a gaze area corresponding to the gaze area information to obtain a target image corresponding to the image data; and
determining feedback information corresponding to the query information according to the query information and the target image.

8. The method according to claim 7, wherein processing the image data according to the gaze area corresponding to the gaze area information to obtain the target image corresponding to the image data comprises:
mapping the gaze area in the image data to obtain a target area corresponding to the gaze area in the image data; and
simplifying the image data based on the target area to obtain the target image corresponding to the image data.

9. The method according to claim 8, wherein simplifying the image data based on the target area to obtain the target image corresponding to the image data comprises:
cropping the image data based on the target area to obtain a first image corresponding to the target area in the image data; and
determining the first image as the target image corresponding to the image data, or reducing resolution of the first image to obtain the target image corresponding to the image data.

10. The method according to claim 5, wherein determining the user head information according to the asymmetric electrode data comprises:
inputting the asymmetric electrode data into a target model to obtain the gaze area information of a user.

11. The method according to claim 10, further comprising:
acquiring historical asymmetric electrode data, and adding a label to the historical asymmetric electrode data to obtain labeled data; wherein the label comprises at least one of: looking upward, looking downward, looking leftward, looking rightward, an identification of a grid, and center point coordinates; the grid is a grid area obtained by grid division on a user window, and different grids have different identifications; and the center point coordinates are coordinates of a center point of an area concerned by the user in the user window;
determining a training sample set according to the labeled data; and
training a model to be trained according to the training sample set to obtain the target model.

12. The method according to claim 6, wherein the query information comprises at least one of: text data, voice data, or video data.

13. The method according to claim 1, wherein the user head information comprises eye movement information, and the method further comprises:
determining a user state according to the eye movement information; and
determining a corresponding processing result according to the user state.

14. The method according to claim 1, further comprising:
determining a human body activity category according to the asymmetric electrode data; and
determining a corresponding processing result according to the human body activity category.

15. The method according to claim 1, further comprising:
determining a material category of an object in contact according to the asymmetric electrode data; and
determining a position of the head-mounted device according to the material category.

16. The method according to claim 1, further comprising:
determining a facial touch action category according to the asymmetric electrode data; and
performing a corresponding operation in response to an instruction generated according to the facial touch action category.

17. A head-mounted device, comprising: a pair of electrodes which are asymmetrically disposed, a processor, and a memory; wherein
the pair of electrodes is used for collecting asymmetric electrode data;
the memory stores computer-executable instructions; and
the processor executes the computer-executable instructions stored in the memory to cause the processor to perform the following information determining operations:
acquiring the asymmetric electrode data; and
determining user head information according to the asymmetric electrode data.

18. The device according to claim 17, wherein the pair of electrodes is made of any one of the following materials: silver plated with silver chloride, copper plated with silver chloride, or copper plated with gold.

19. A non-transitory computer-readable storage medium having stored thereon computer-executable instructions which, when executed by a processor, implement the following information determining operations:
acquiring asymmetric electrode data; wherein the asymmetric electrode data is collected by a pair of electrodes which are asymmetrically disposed, wherein the pair of electrodes is comprised in a head-mounted device; and
determining user head information according to the asymmetric electrode data.
